(19) United States
(12) Patent Application Publication
(10) Pub. No.: US 2002/0034304 A1
(43) Pub. Date: Mar. 21, 2002

(54) Method of preventing illegal copying of an electronic document

(76) Inventor: Ta-Kuang Yang, Taipei (TW)

Correspondence Address: WINSTON HSU, SF. 389, FU-HO ROAD, YUNGHO CITY, TAIPEI, TW

(21) Appl. No.: 09/682,256

(22) Filed: Aug. 10, 2001

(30) Foreign Application Priority Data
Aug. 11, 2000 (TW) 089116219

(51) Int. Cl. H04L 9/00

(52) U.S. Cl. 380/281; 705/57

(57) ABSTRACT

A method prevents illegal copying of an electronic document in a computer system. The computer system has a server for connecting to a plurality of terminals via a network. Each terminal has a terminal identification code for identifying the terminal, and each terminal is capable of requesting an electronic document from the server via the network. The server is capable of encrypting original plaintext of the electronic document to a corresponding ciphertext. The ciphertext is capable of being transmitted to the terminal via the network and being decrypted to the original plaintext. The method has a registration process and a document request process.

### BACKGROUND OF INVENTION

1. Field of the Invention

The present invention relates to a method of preventing illegal copying of an electronic document in a computer system, and more particularly, to a method of preventing downloading of an electronic document to an electronic reading device via a network, and illegal copying the document to other devices.

2. Description of the Prior Art

Traditionally, knowledge was spread by books or magazines printed on paper. The knowledge spread sped up with an emergence of radio and television. Now, knowledge and information are transmitted worldwide with the rapid development of computer transmission and networks. As a result of the development of internet technology, there are many new business operation modes created that use the internet to do business in common. This has been given the name electronic commerce, or E-commerce for short. For example, traditionally if you want to buy some books, you must personally go to a bookstore or ask someone else to buy the books for you. With the emergence of the internet, consumers can now search for the desired books and buy them on-line at electronic bookstores, such as AMAZON.com. It makes purchasing books easier, but there is still one flaw, which is storage of the books. The more books you buy, the more space you need to place them. Meanwhile, it is more difficult to manage them.

Accordingly, the concept of using an “electronic reading device” is submitted to apply to this case. Texts or pictures of the original book are digitalized to generate an electronic book. Consumers only need one terminal connected to the network, and some particular software, to buy desired electronic books or documents online easily. The user downloads the electronic book to the terminal which he uses, then starts reading it. Terminals that can meet such a requirement are so-called electronic reading devices. Many publication enterprises engaged in the business of electronic bookstores and electronic books because of the enormous market, but the plans were cut as some operational mechanisms were not organized yet. One of the reasons is the worry about such an un-matured market owing to the user's reading habit. In other words, most consumers are used to reading books made of paper. Anyone who wants to push the idea of reading electronic books by electronic reading devices must overthrow consumers' inveterate reading habits, requiring a long period of education and accommodation. But, another more important factor is the low cost of republication and easy spreading capability. The market of electronic books is seriously threatened with the problem of expansion.

The serious threat comes from sellers who engage in trade of electronic books. The sellers encounter a problem which is hard to solve. Electronic books can easily be copied many times to share with someone who is not the seller or the buyer. The electronic book is so convenient because it is an invisible electronic file. Compared with traditional books which are visible and substantial, it is convenient to deliver electronic books and saves a lot of space for placement. For, it is easy to deliver invisible electronic files, so that consumers can illegally copy, deliver, and spread the electronic books to others after legally buying them. That is to say, if we can not design a mechanism for the electronic-book trade to avoid buying the books legally, but delivering the books illegally, one electronic book sold by a seller to one consumer means many copies delivered to others for free.

Under such circumstances, sellers can not make reasonable profits. This kind of electronic commerce can not exist without doubt. This is an important reason why electronic books are not as popular as expected. Using electronic books has many advantages as follows. Using no paper materials is better for the environment. Electronic books are delivered more quickly. Electronic books are more economical, without wasting much space.

Electronic books can save many valuable resources. It is a big loss to the economy if electronic books do not become popular as a result of not being able to solve the problems mentioned above.

### SUMMARY OF INVENTION

The present invention provides a method for preventing illegal copying of an electronic document in a computer system. The computer system has a server for connecting to a plurality of terminals via a network.Each terminal has a terminal identification code for identifying the terminal,and each terminal is capable of requesting an electronic document from the server via the network. The server is capable of encrypting original plaintext of the electronic document to a corresponding ciphertext. The ciphertext is capable of being transmitted to the terminal via the network and being decrypted to the original plaintext. The method has a registration process and a document request process.

It is therefore an objective of the present invention to provide a method of preventing illegal copying of an electronic document in a computer system, especially a method that not only prevents downloading an electronic document to one electronic reading device via a network, but also prevents illegal copying of an electronic document to other electronic reading devices, thereby solving the problems mentioned above.

These and other objectives of the present invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a schematic diagram of a computer system according to the present invention, which can prevent illegal copying of an electronic document.

FIG. 2 is a function diagram of a server.

FIG. 3 is a function diagram of a terminal.

FIG. 4 is a flow chart of a procedure of registration.

FIG. 5A is a flow chart of a server procedure of retrieving documents.

FIG. 5B is a flow chart of a client procedure of retrieving documents.

### DETAILED DESCRIPTION

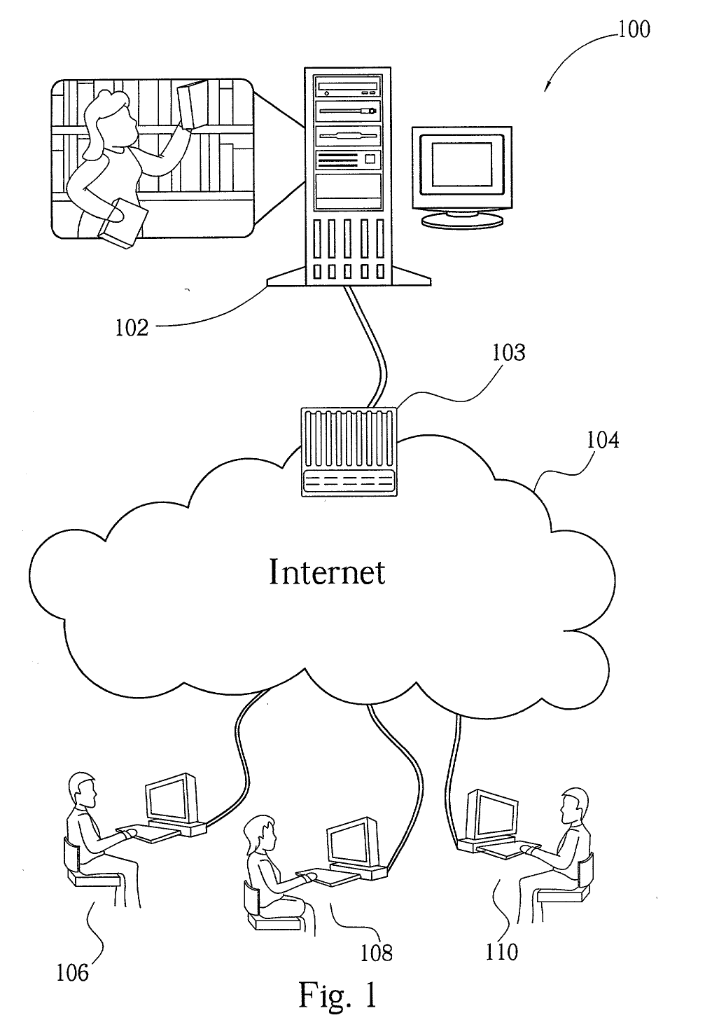

Please refer to FIG. 1, which is a schematic diagram of a computer system 100, according to the present invention, preventing illegal copying of an electronic document.

The computer system 100 comprises a server 102 connected to a network 104 via a firewall 103. A plurality of users can connect to the network 104 by terminals 106, 108, 110. The firewall 103 is used to isolate the server 102 from the outer network 104. In order to protect the settings and data from illegal hacking and revision, only certain network services and network messages, such as registered remote log-in, e-mail, and file transferring, can go through the firewall 103 after undergoing package filtering. Each of the terminals 106, 108, 110 could be a desktop computer, a notebook computer, a personal digital assistant, or a WAP cellular phone, which can connect to the network. As long as the user's terminal can connect to the network and transfer digital information, it is suitable for use in the computer system 100 for preventing illegal copying.

For the preferred embodiment, terminals 106, 108, 110 are desktop computers and each of them comprises a central processing unit(CPU), a hard-disk, a network card, input devices such as a keyboard, a mouse, and a joypad, and output devices such as a monitor, and a printer. Each of the terminals 106, 108, 110 at least has its own unique computer identification code used as the terminal's identification. The terminal identification code is selected from one of a set of identification codes coming from the CPU, the hard-disk, or the network card, and the server 102 can check the identity and location of each terminal 106, 108, 110 when doing electronic business or transferring data.

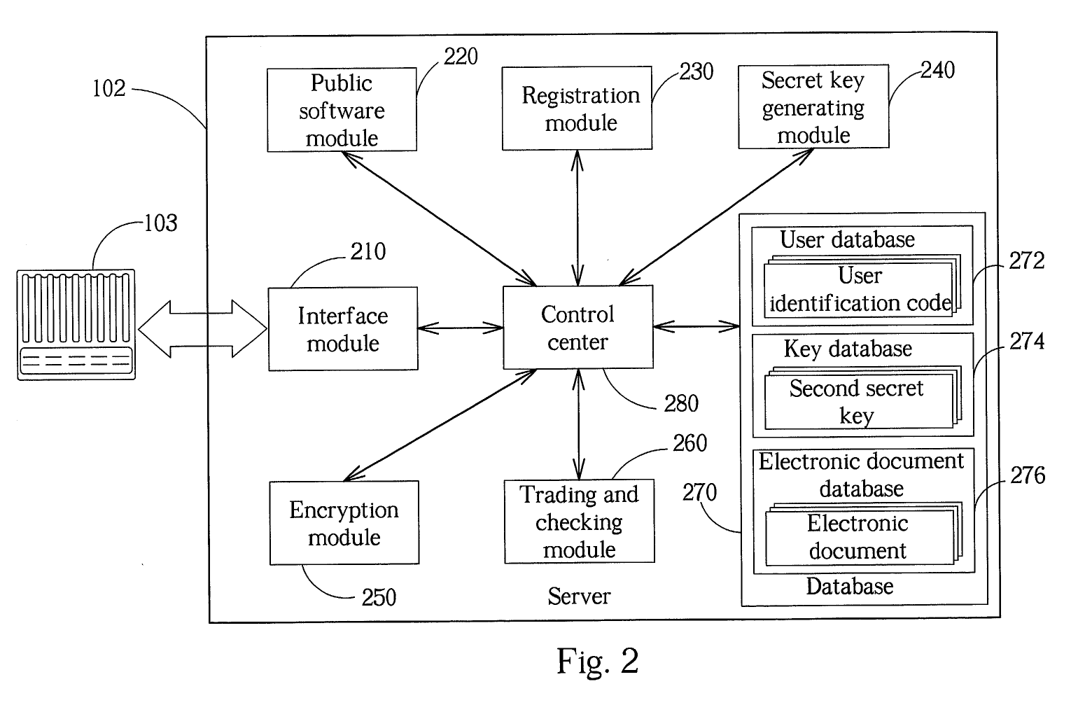

Please refer to FIG. 2, which is a function diagram of the server 102 of the computer system preventing illegal copying. The server 102 comprises an interface module 210, a public software module 220, a registration module 230, a secret key generating module 240, an encryption module 250, a trade management and confirmation module 260, a database 270, and a control center 280.

Data are transmitted between the server 102 and the network 104 via the firewall 103 which is connected by the interface module 210. It is necessary for the server 102 to transfer different data formats to appropriate receivers. The public software module 220 on the server 102 stores various public software that users can download to their own terminals for free. For example, one compiled reading application program, which provides the user with an operational interface for registering, downloading, and reading electronic books, comprises a first secret key. The function of the first secret key is discussed later. A registration module 230 accepts the registration of the user and the assigned terminal. It makes the user a legal registered user and the assigned terminal a legal registered terminal, which can download electronic books legally. The secret key generating module 240 generates a second secret key specified for a user on registering. In other words, different users get different second secret keys. It is necessary to explain that the first secret key and the second secret key mentioned above are digital streams of pre-defined size. For instance, the stream may be 56 bits or 128 bits long. The preferred embodiment of the present invention implements keys of 128 bits or longer to reinforce security.

The encryption module 250 is used to execute any encryption needed. For example, on retrieving the document the encryption module 250 encrypts the electronic book, which the user purchases, with a specific second secret key owned by the user and then delivers the document to the end-user. The trade management and confirmation module 260 is used to handle orders of consumers, and make necessary confirmations of origins and contents of orders. The database 270 comprises at least three sub-databases: a user database 272, a key database 274, and an electronic document database. The user database 272 records a plurality of data of registered users and assigned terminals. For example, the user database 272 stores a user identification code of a user. The key database 274 records the user identification codes of the registered users, and the associated second secret keys. In other words, when users are registering, the second secret keys associated with specific users are generated from the secret key generating module and stored in the key database 274. The electronic document database 276 is used to store associated plaintexts of a plurality of electronic documents which are supplied to the users later. Every electronic book contains one particular electronic code in order to search easily and build a file system. The control center 280 is used to control the operation of the server 102, and to deal with every module of the server 102, the control of the database, or the flow of data streams.

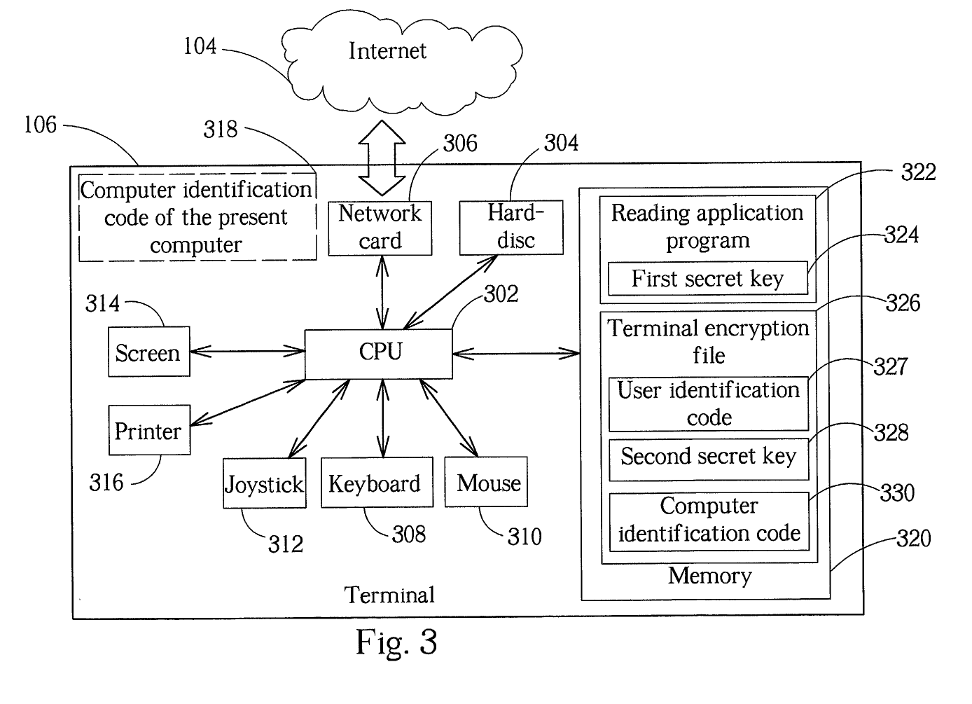

Please refer to FIG. 3, which is a function diagram of the terminal 106, 108, 110 of the computer system preventing illegal copying. Taking terminal 106 for example, the preferred embodiment of the terminal 106 according to the present invention is a desktop computer which comprises a CPU 302, a memory module 320, a hard-disk 304, a network card 306, input devices such as a keyboard 308, a mouse 310, and a joypad 312, and output devices such as a monitor 314, and a printer 316. In order to exchange data between the server 102 and the terminal 106, the terminal 106 must get a compiled reading application program 322 downloaded from the server 102 or the network 104 to store in the memory module 320 or the hard-disk 304. The reading application program 322 provides the user an operational interface for registering, downloading, or reading electronic books. There is a first secret key added in the reading application program 322 to decrypt the terminal encryption file 326. Even for the different users, the reading application programs 322 required are the same. The reading application program 322 must be compiled first, so that the users can download it for free. And, the first secret keys 324 are the same for different users.

The user uses the reading application program of the terminal 106 as one interface to login and register to the server 102.The process contains 4 steps.

Step 1. The server 102 identifies whether such a reading application program is a legal one.

Step 2. The server 102 makes use of the registration module 230 to create a specified user identification code, and the secret key generating module 240 to create a corresponding second secret key.

Step 3. The server 102 adds the user identification codes to the user database 272 and the second secret keys to the key database 274.

Step 4. A reading application of the terminal 106 downloads the user identification code and the second secret key. After the terminal 106 is registered, there is a terminal encryption file 326 which contains a user identification code 327, a user-specified second secret key 328, and a terminal identification code 330 for the terminal 106. The terminal 106 encrypts the terminal encryption file 326 with the first secret key 324, and stores the encrypted file in the memory module 320 or on the hard-disk 304. This prevents the present user from modifying it, and protects the data from being read illegally by others. When the electronic book is downloaded and needs to be decrypted, the reading application program 322 decrypts the terminal encryption file 326 with the first secret key 324 to get the second secret key 328 and the terminal identification code 330.

The method of the present invention is described thoroughly as follows. There is one process of registration and one process of retrieving documents contained in the computer system for preventing illegal copying 100 according to the present invention. Before the user purchases electronic documents with the computer system 100, he must download the reading application program 322 from the server 102 or the electronic bookstores located on the network 104. Then, the consumer uses the reading application program 322 to register as a legal registered user or member to the server 102. The reading application program 322 contains not only a general interface application program, but also a first secret key 324 as mentioned above. On registering, not only the user must be registered, but the terminal 106 which the user uses to download electronic books must also be registered. That is to say, the related fundamental data of the user, including the user identification code and the corresponding second secret key 328, are recorded on the server 102 on registering. And, the user must use the registering terminal 106 as the reading application program for downloading electronic books later. Otherwise, the computer system 100 views the electronic device which downloads electronic books as un-registered, and can not open the downloaded electronic books normally. When the user uses the reading application program 322 of the terminal 106 to register, the server 102 records the user identification code in the user database and assigns a specified second secret key 328 to the user. At the same time, the 1-on-1 index table showing the relationship between the user and his corresponding second secret code 328 is recorded in the key database 274. Now both the user and the terminal 106 have finished the process of legal registration. After finishing the process of registration, the server 102 encrypts the user identification code 327 and the specified second secret code 328 corresponding to the user with the first secret key. The encrypted data is transmitted to the terminal 106. The encrypted user identification code 327 and the specified second secret code 328 corresponding to the user are decrypted first on the terminal 106. Then the original user identification code 327 and the specified second secret code 328 corresponding to the user together with the terminal identification code of the terminal 106 are encrypted together to generate a terminal encryption file 326 which is recorded on the legal registered terminal. The terminal 106 later can download electronic books legally and decrypt them correctly after such a process of registration.

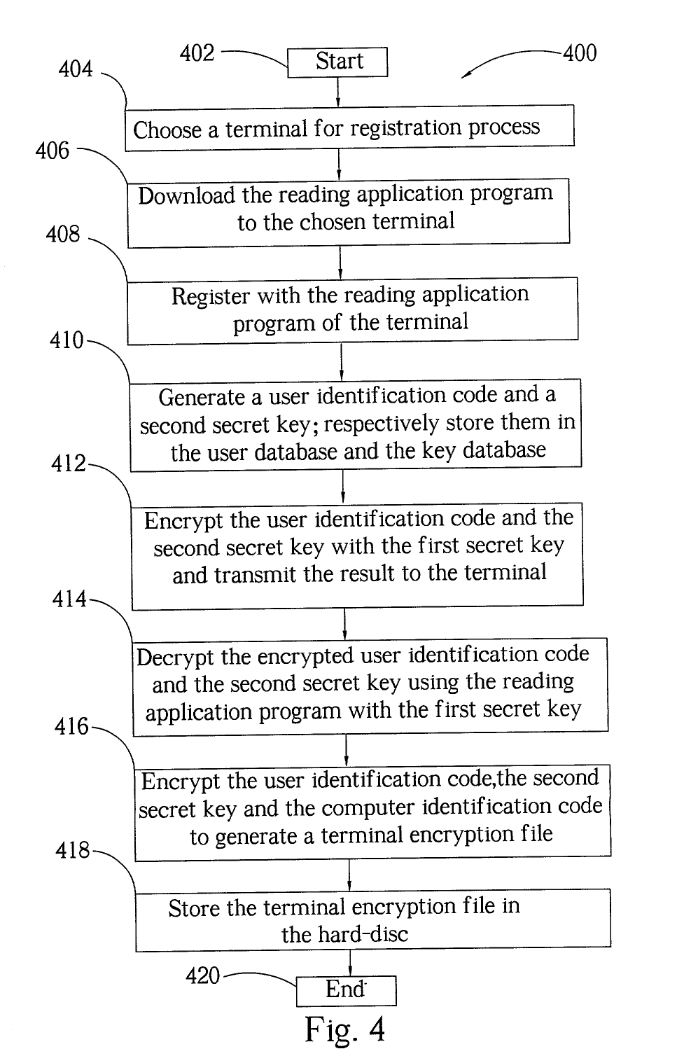

Please refer FIG. 4, which is a flow chart of the procedure of registration of the computer system according to present invention. The procedure of registration as mentioned above is illustrated by the flow chart 400 as follows: Step 402: Begin.

Step 404: The user selects one terminal 106 to register upon later.

Step 406: Download the reading application program 322 to the specified terminal 106 from the network 104.

Step 408: The reading application program 322 of terminal 106 starts registering by connecting a server 102.

Step 410: The server 102 generates the user identification code and the specified second secret key, which are separately stored on the user database 272 and the key database 274.

Step 412: The server 102 encrypts the user identification code and the specified second secret key with the first secret key, and transmits the encrypted data to the terminal 106.

Step 414: On receiving the encrypted data, the reading application program of the terminal 106 decrypts both the encrypted user identification code and the specified second secret key right away.

Step 416: The original user identification code 327 and specified second secret code 328 corresponding to the user together with the terminal identification code of the terminal 106 are encrypted together to generate a terminal encryption file 326 by the reading application program of terminal 106.

Step 418: The reading application program of terminal 106 records the terminal encryption file 326 onto the hard-disk.

Step 420: Finish.

When both the user and the terminal 106 complete the registration to the server 102, the user can purchase particular electronic books on-line anytime, and download them to the terminal 106. Described above is the so-called procedure of retrieving documents. The user can surf the electronic bookstores or related webs of the network 104 by registered terminals, search for electronic books, and then make a decision to buy electronic books. Then, the user submits the order to the server 102. The server 102 searches the plaintext of the electronic document from the electronic document database 274, and searches the specified second key 328 of the user from the key database 274. Then, the plaintext of the original electronic document is encrypted to a corresponding ciphertext with the second secret key 328. The ciphertext is transmitted to the terminal 106 via the network 104.

When the reading application program 322 of terminal 106 receives the ciphertext of the purchased electronic document, it decrypts the terminal encryption file 326 with the first secret key 324 to get the second secret key 328 and terminal identification code included. Then, the reading application program 322 compares the original terminal identification code of the decrypted terminal encryption file with that of the present terminal 106. When they match correctly, the current terminal 106 is a legally registered one. The reading application program 322 continues to decrypt the ciphertext to the original plaintext with the second secret key 328 extracted from the decryption of the terminal encryption file 326. The user can read the plaintext under the interface provided by the reading application program 322.

If the reading application program 322 compares the terminal identification code extracted from decryption with that of the terminal 106 and both fail to match, then the terminal 106 is not a legally registered terminal. The reading application program stops working, and can not decrypt the received ciphertext with the second secret key 328 as usual. So the user can not read the electronic document. The most possible reason under such circumstances is that the registered user downloads the electronic document legally, but copies the reading application program 322, including the electronic document and the terminal encryption file 326, to another computer for the purpose of being read by others.

It is so-called “purchase legally, but deliver illegally”.

However, the reading application program 322 compares the terminal identification code 330 extracted from the terminal encryption file 326 with the terminal identification code 318 of the current decrypting computer to get one result. If the current decrypting computer is the same as the previous registering terminal, the comparisons match, meaning that the current computer performing decrypting is the same as the legally registered terminal, and the electronic document is not illegally delivered to un-registered computers. The reading application 322 proceeds to decrypt the electronic documents for the user to read. If the current decrypting computer is not the same as the previous registering terminal, the comparisons so not match, meaning that the current computer performing decrypting is not a legally registered one, and the electronic documents are illegally delivered to other unregistered computers. The reading application program 322 ceases the operation of decryption, and the user can not read the illegal delivered electronic document by decrypting it.

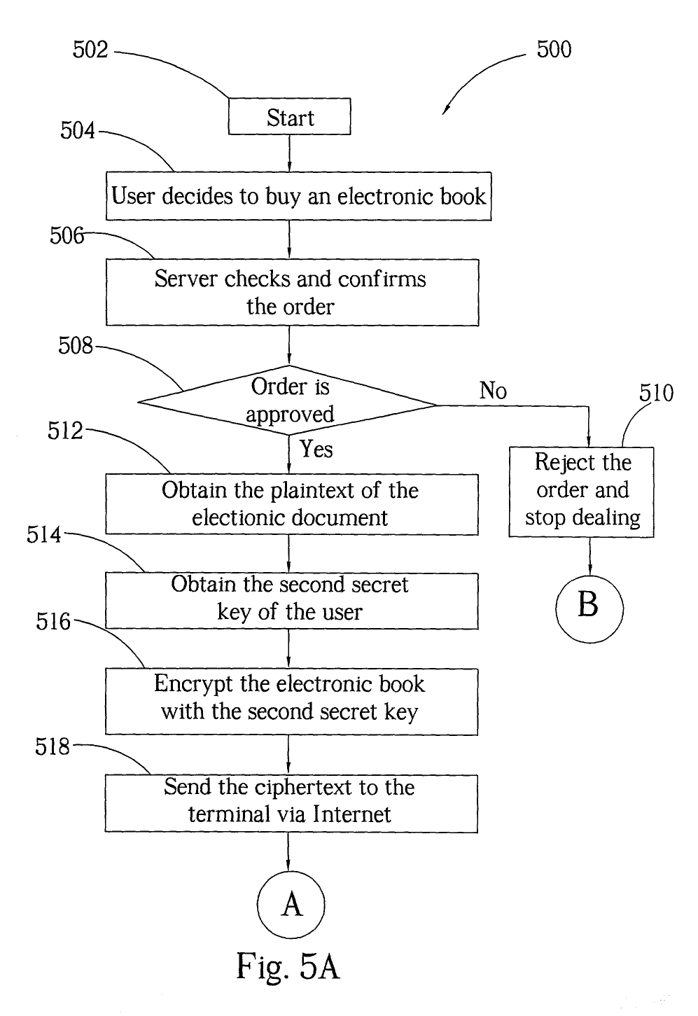

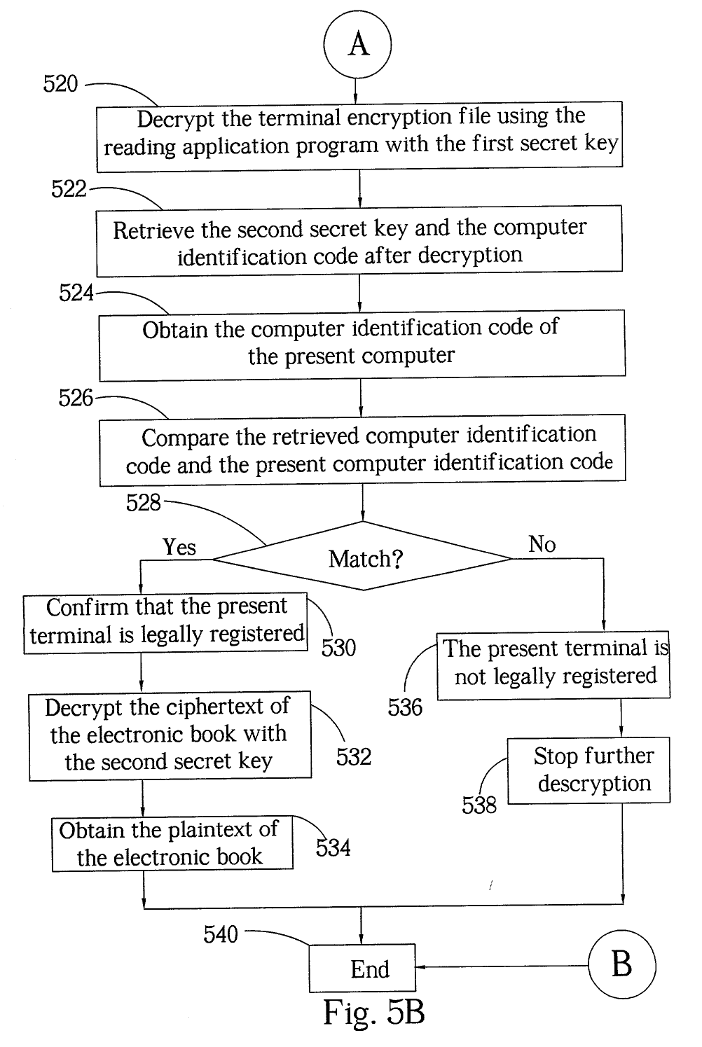

Please refer FIG. 5A, which is a flow chart of a procedure of retrieving documents on the server according to the present invention. FIG. 5B is a flow chart of the procedure of retrieving documents on the client according to the present invention. The procedures mentioned above are illustrated as follows.

Step 502: Begin; Step 504: The user decides to buy one electronic book in the electronic bookstore; Step 506: The server 102 handles the order, and makes certain necessary confirmations and checks; Step 508: Is the order confirmed? If yes, go to Step 512. If no, go to Step 510; Step 510: Reject this order and stop the trade immediately; go to Step 540; Step 512: Select out the plaintext of the electronic document from the electronic document database 276; Step 514: Select out the specified second secret key 328 of the user from the key database 274; Step 516: Encrypt the plaintext of the electronic document to a corresponding ciphertext with the second secret key 328; Step 518: Transmit the ciphertext to the terminal 106 via the network 104; Step 520: The reading application program 322 of the terminal 106 decrypts the terminal encryption file 326 with the first secret key 324; Step 522: Retrieve the second secret key 328 and the terminal identification code 330 after decrypting.

Step 524: Retrieve the terminal identification code 318 of the current working computer; Step 526: The reading application program 322 compares the terminal encryption file 330 from decrypting with the terminal encryption file 318 of present computer; Step 528: Do the comparisons match? If yes, go to Step 530. If no, go to Step 536; Step 530: The current terminal 106 is certified to be a legal registered one.

Step 532: The reading application program 322 decrypts the received ciphertext of the electronic document with the second secret key 328; Step 534: The user reads the electronic document after decrypting. Go to Step 540; Step 536: The present terminal is not a legal registered one; Step 538: The reading application program 322 ceases the operation of decrypting; Step 540: Finish.

The preferred embodiment of the present invention as mentioned is the private key crypto system. A user uses the same secret key to encrypt and decrypt the electronic document. It is called a symmetrical key crypto-system as nobody knows the content of the secret key except for the people who transfer data to each other. The DES algorithm published by ANSI (American National Standards Institute), or the IDEA algorithm designed by Lai and Massey has a better security, and a faster speed of encrypting and decrypting. However, the computer system 100 of the present invention uses the public key crypto-system to encrypt and decrypt the electronic document. Every user has a public key of his own published to the public, and one private key which is not known by others. The encryption module 250 of the server 102 encrypts the electronic document with the user's public key, and the reading application program 322 decrypts the received ciphertext of the electronic document with the user's private key.

Compared to the prior art, the present invention of the computer system 100 has many advantages as follows.

1. Different users and terminals need the same reading operation platform. Because all users use the reading application program 322 to process registering and document retrieving with the server 102, the reading application program 322 becomes a reading operation platform as a communicating bridge between the user and the server 102. The reading application program 322 and the first secret key 324 included are compiled first to be downloaded by users for free or copied to any computer. One objective of the present invention is prevention of any obstacles when popularizing electronic documents. The electronic documents are prevented from being delivered illegally, but not the reading application program 322 itself. It makes no difference to the present invention whether users download, copy, or deliver the reading application program 322. Actually, it helps in promoting electronic documents to users, and makes the use of electronic documents more popular.

2. When the user is registering for his assigned terminal, the key generation module 240 of the server 102 generates one specific second secret key for the present user. When the user purchases an electronic document, the encryption module 250 encrypts the plaintext of the electronic document to a corresponding ciphertext, which is transmitted to the terminal that the user uses. After the terminal is confirmed as a legally registered terminal by the reading application program 322 of the same terminal, the ciphertext of the electronic document is decrypted with the second secret key 328. Some prior art methods use the same secret key to decrypt electronic documents purchased by different users. Once the secret key is hacked, all ciphertexts of the electronic documents can be decrypted to their original plaintexts. However, every user has a specified second secret key of his own according to the present invention. Even if the second secret key owned by one of the users is hacked, other users' electronic documents are safe from being read. The security is improved under such a system.

3. The terminal encryption file stored on the hard-disk is encrypted. Doing this prevents the contents from being modified by the user, and it protects the contents from being read illegally.

4. The terminal encryption file stored on the terminal helps simplify the complex user agreement procedure on the disclosure of personal private information by uploading the terminal identification code. Owing to the present invention, the terminal identification code required for checking whether a registered terminal is composed of the identification code of the CPU, the identification code of the hard-disk, or the identification code of the network card. Those identification codes are viewed as a part of users' personal private information, and the server 102 must get the agreement of users to collect such identification codes. The server 102 can not avoid the procedure of user's agreement on getting the terminal identification codes, so that the procedure of checking for a registered terminal makes security more complex fundamentally. According to the design of present invention, both the user identification code and the second secret code downloaded are decrypted. Then, those decrypted codes and the terminal identification code of the assigned terminal are encrypted with the first secret code to generate the corresponding terminal encryption file. There is no need to upload the terminal identification code to the server 102 on registering. When the terminal receives the ciphertext of the electronic document, the terminal identification code required in the preceding certification is stored on the terminal directly. So, the terminal identification code of the present terminal is not transmitted to the server 102. The work of comparison and certification is performed on the terminal directly. The probable debate and the complex process of the agreement on the disclosure of user's personal private information is reduced and simplified.

5. Comparing the terminal identification code 330 retrieved from the terminal encryption file 326 with the terminal identification code 318 of the current decrypting computer prevents buying legally but delivering illegally. Before the reading application program 322 of the present invention starts decrypting the electronic document, it first compares the terminal identification code 330 retrieved from the terminal encryption file 326 with the terminal identification code 318 of the current decrypting computer to make sure that the current decrypting computer is the same as the one which has registered. Then the reading application program 322 makes a judgment as to whether or not to continue decrypting the ciphertext of the electronic document. Even if the ciphertexts of electronic documents are delivered to other un-registered computers illegally, the reading application program 322 ceases the process of decrypting. So the illegally delivered electronic documents can not be read because they can not be decrypted exactly.

In summary,the computer system of present invention brings up one effective mechanism to prevent illegal copying of an electronic document by one unregistered terminal. Meanwhile, it prevents buying legally but delivering illegally, such that dealers in electronic documents are more willing to engage in the business of selling electronic documents for earning reasonable profits. The advantages of the electronic documents which include better environmental protection, better efficiency, easier delivery, and better economy are thereby shared with the public.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method to prevent illegal copying of an electronic document in a computer system, the computer system comprising a server for connecting to a plurality of terminals via a network, each terminal having a terminal identification code for identifying the terminal, each terminal capable of requesting an electronic document from the server via the network, the server capable of encrypting original plaintext of the electronic document to a corresponding ciphertext, the ciphertext capable of being transmitted to the terminal via the network and being decrypted to the original plaintext, the method comprising a registration process and a document request process, the registration process comprising:
installing a reading application program in a terminal, the reading application program comprising a first secret key;
utilizing the reading application program to register the terminal with the server;
encrypting and transmitting to the terminal a user identification code and a second secret key, the user identification code and the second secret key being generated by the server; and
generating a terminal encryption file by encrypting the user identification code, the second secret key, and the terminal identification code, the terminal encryption file being stored in the terminal;
the document request process comprising:
a terminal requesting the server for an electronic document, the server using the second secret key to encrypt plaintext of the electronic document to corresponding ciphertext, the ciphertext being transmitted to the terminal via the network;
using the first secret key to decrypt the terminal encryption file to retrieve the second secret key and the terminal identification code; and
utilizing the retrieved second secret key to decrypt the received ciphertext if a run-time terminal identification code corresponds to the terminal identification code retrieved from the terminal encryption file, otherwise terminating further decryption to prevent illegal copying of the electronic document by unregistered terminals.

2. The method of claim 1 wherein the terminal further comprises a central processing unit (CPU), a hard-disk, and a network card, and the terminal identification code is selected from one of an identification code from the CPU, the hard-disk, or the network card.

3. The method of claim 1 wherein the server comprises a user database for recording a plurality of user identification codes of registered users, and terminal identification codes.

4. The method of claim 3 wherein the server comprises a secret key generating module for generating a second secret key for each user registered in the user database.

5. The method of claim 4 wherein the server comprises a key database for recording the user identification codes of the registered users, and the associated second secret keys.

6. The method of claim 1 wherein the server comprises an encryption module for encrypting and transmitting to the terminal the second secret key and the user identification code.

7. The method of claim 6 wherein the server comprises an electronic document database for storing associated plaintexts of a plurality of electronic documents, and a control center for controlling operations of the server.

8. The method of claim 7 wherein when the server receives a request for the electronic document by the terminal, the control center locates the associated plaintext of the electronic document, and the encryption module encrypts the plaintext of the electronic document with the second secret key to form the corresponding ciphertext.

9. The method of claim 1 wherein the first secret key and the second secret key are both 128-bit encryption keys.

10. The method of claim 1 wherein the server comprises a public software module for storing the reading application program to be downloaded to the terminals by users.

11. A computer system to prevent illegal copying of an electronic document, the computer system comprising a server for connecting to a plurality of terminals via a network, each terminal having a terminal identification code for identifying the terminal, the terminals capable of requesting an electronic document from the server via the network, the server capable of encrypting original plaintext of the electronic document into a corresponding ciphertext, the ciphertext being transmitted to the terminal via the network and being decrypted to the original plaintext, the server comprising:
a public software module for storing a reading application program to be downloaded to the terminals, the reading application program comprising a first secret key;
a registration module, capable of generating a user identification code on registration of a terminal;
a secret key generating module for generating a second secret key specified for a registered user; and
an encryption module capable of encrypting and transmitting the user identification code and the second secret key transmitted to a registered terminal;
wherein when the reading application program of the terminal receives the user identification code and the second secret key, a terminal encryption file is generated by encrypting the user identification code, the second secret key and the terminal identification code, and the terminal encryption file is stored in the registered terminal wherein when a terminal requests the server for an electronic document, the encryption module encrypts plaintext of the electronic document as the corresponding ciphertext with the second secret key, and the ciphertext is transmitted to the terminal via the network, and when the reading application program of the terminal receives the ciphertext, the first secret key is used to decrypt the terminal encryption file to retrieve the second secret key and the terminal identification code, and when the reading application program identifies a run-time terminal identification code that matches the terminal identification code retrieved from the terminal encryption file, the retrieved second secret key is used to decrypt the received ciphertext, otherwise, further decryption is terminated to prevent illegal copying of the electronic document by an unregistered terminal.

12. The computer system of claim 11 wherein the terminal further comprises a central processing unit (CPU), a hard-disk, and a network card, and the terminal identification code is selected from one of identification codes from the CPU, the hard-disk, or the network card.

13. The computer system of claim 11 wherein the server comprises a user database for recording a plurality of user identification codes of the registered users and the associated terminal identification codes.

14. The computer system of claim 11 wherein the server comprises a key database for recording all the registered users and the specified second secret keys.

15. The computer system of claim 11 wherein the server comprises an electronic document database for storing the plaintext of the plurality of electronic documents, and a control center for controlling operations of the server.

16. The computer system of claim 15 wherein after receiving a request for an electronic document by a terminal, the control center of the server locates the plaintext of the electronic document, and the encryption module encrypts the plaintext of the electronic document with the second secret key to form the corresponding ciphertext.

17. The computer system of claim 11 wherein the first secret key and the second secret key are both 128-bit encryption keys.
